(19) United States
(12) Patent Application Publication
(10) Pub. No.: US 2018/0081670 A1
(43) Pub. Date: Mar. 22, 2018

(54) PRIORITIZATION OF UPDATES FOR OVER-THE-AIR DISTRIBUTION

(71) Applicant: FORD GLOBAL TECHNOLOGIES, LLC, Dearborn, MI (US)

(72) Inventors: Brunilda Bleta CAUSHI, Northville, MI (US); John Naum VANGELOV, South Lyon, MI (US)

(21) Appl. No.: 15/271,850

(22) Filed: Sep. 21, 2016

(51) Int. Cl. G06F 9/445; H04L 29/08

(52) U.S. Cl. CPC G06F 8/65; H04L 67/18; H04L 67/34

(57) ABSTRACT

Priority data is accessed to determine a priority of a software update specific to a vehicle to be updated. The software update is pushed to a vehicle responsive to the priority indicating that the software update is an add-on authorized for use by the vehicle. Otherwise, the software update is scheduled to the vehicle at a time according to the priority and a geographic region of the vehicle.

### TECHNICAL FIELD

The present disclosure relates to systems and methods for providing prioritized over-the-air (OTA) software updates to a vehicle.

### BACKGROUND

One or more software and/or hardware components of a vehicle may require periodic or occasional electronic updates. In one example, the updates may include changes to the software or settings of the vehicle to address an issue or to provide improved functionality to current software or settings. In another example, the updates may include updated configuration settings for one or more vehicle controllers and/or updated versions of software or firmware to be installed on the one or more vehicle controllers.

The vehicle may be configured to receive electronic updates via a wired or a wireless connection. In one example, a technician at a car dealership or a service shop may download the updates onto the vehicle using a wired land access network (LAN) connection. In another example, the vehicle may be configured to receive over-the-air (OTA) software updates, such as software updates received via a wireless connection to a server.

### SUMMARY

In one or more illustrative embodiments, a system includes a server programmed to access stored priority data to determine a priority of a software update specific to a vehicle to be updated, responsive to the priority indicating that the software update is an add-on authorized for use by the vehicle, schedule the software update for immediate push, and otherwise, schedule the software update to the vehicle at a time according to the priority and a geographic region of the vehicle.

In one or more illustrative embodiments, a method includes including, in a data store, priority data for a software update to a vehicle based on metadata of the software update; responsive to receiving an indication of a vehicle-specific priority for the software update for the vehicle, updating the priority data with the vehicle-specific priority override; and scheduling the software update to the vehicle at a time according to the vehicle-specific priority and a geographic region of the vehicle.

In one or more illustrative embodiments, a non-transitory computer-readable medium comprising instructions, that when executed by a processor, cause the processor to schedule a software update to a vehicle at a time specific to a priority determined using metadata of the software update and a geographic region in which the vehicle identifies in a message to the processor as being located.

### BRIEF DESCRIPTION OF THE DRAWINGS

FIG. 1 is a block diagram illustrating a vehicle-based computing platform;

FIG. 2 is a block diagram illustrating an in-vehicle software update server and multiple regional software delivery networks in communication with a vehicle;

FIG. 3 is a data flow diagram illustrating the delivery of an updated region identifier to be associated with the vehicle;

FIG. 4 is a data flow diagram illustrating the delivery of software updates using the regional software delivery networks;

FIG. 5 is a flowchart illustrating an algorithm for updating the region associated with the vehicle;

FIG. 6 is a flowchart illustrating an algorithm for providing software updates to the vehicle based on updated region;

FIG. 7 illustrates an example process for updating software updates;

FIG. 8 illustrates an example process for determining software updates for a vehicle; and

FIG. 9 illustrates an example process for providing instructions to the vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In many software update systems, a push of a new software update may occur as a bundle in a FIFO (first in, first out) manner. However, this manner of software updates does not provide for control regarding the type of the updates to push, and also fails to give the customers an ability to choose which updates they deem to be the most desirable.

In order to decide which software updates to push to a vehicle and in what order, a system may identify which update or updates are the most critical to or most desired by the customer. For instance, an engineer may assign a priority to each software release available for download based on the fix or other functionality embodied by the update. The engineer may also be able to assign a priority preference of the software update per vehicle (e.g., according to vehicle VIN). This may be used by the engineer to push a software update that is not mandatory as a high priority update. On the vehicle side, a customer may be able to pay for a specific update, thereby increasing the priority of the update. Additionally or alternatively, the customer may have the ability to overwrite the priority and time of the updates that will provided for download.

As an example set of priorities, a Priority 1 update may indicate a Mandatory fix (e.g., for any software fixes that are fixing issues that the government would require a recall), a Priority 2 update may indicate that the customer has authorized the update (e.g., paid for the update), a Priority 3 update may indicate a software update to fix noticeable issues in one or more features, a Priority 4 may indicate a software update to provide new features to customers, a Priority 5 update may indicate a software update to fix unnoticeable issues, a Priority 6 update may indicate a preferred update, and a Priority 7 update may indicate a non-imminent update to be scheduled at a customer-specific time.

The system may perform updates to the vehicles based on the priorities set for the vehicle. In an example, a scheduler may perform immediate updates of high priority or preferred priority updates and perform later scheduled updates of lower priority updates. In some cases, the system may update the priorities of the updates based on the region of the vehicle. Moreover, the system may update the scheduler with a time per region of the vehicle and per priority set. Further aspects of the disclosure are discussed in detail below.

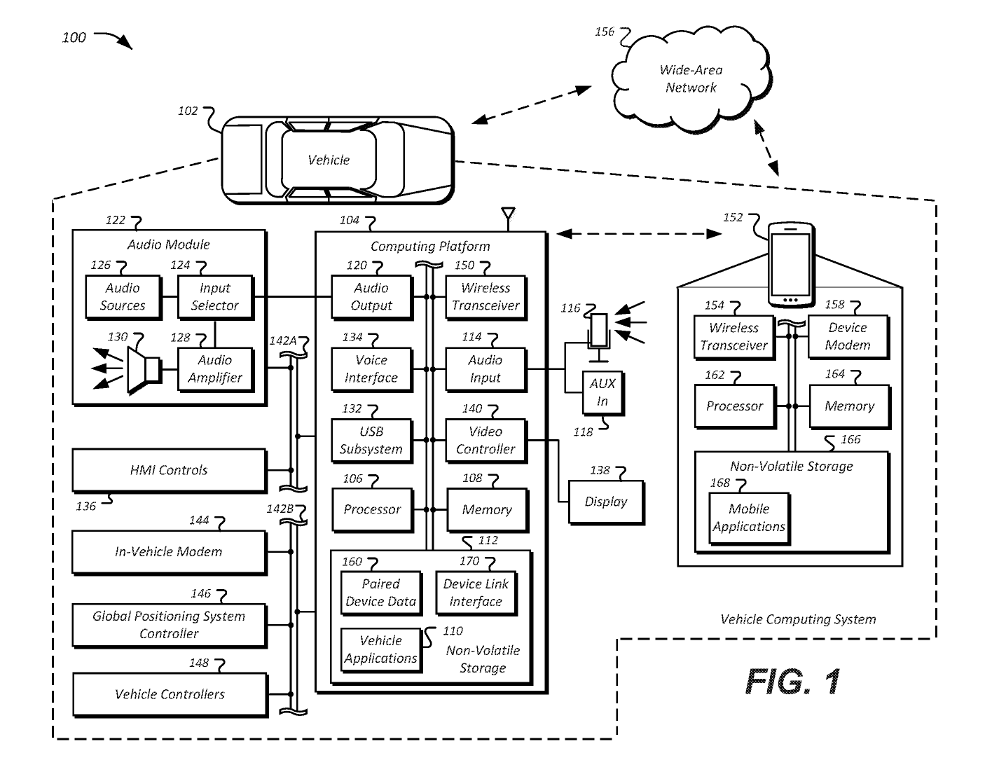

FIG. 1 illustrates an example diagram of a system 100 that may be used to provide telematics services to a vehicle 102. The vehicle 102 may be of various types of passenger vehicles, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

A computing platform 104 may include one or more processors 106 connected with both a memory 108 and a computer-readable storage medium 112 and configured to perform instructions, commands, and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory (e.g., tangible) medium that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a wired jack, such as a stereo input, or a wireless input, such as a Bluetooth® audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of the audio playback functionality of the audio controller 122. In other examples, the computing platform 104 may provide audio output to the occupants through use of one or more dedicated speakers (not illustrated). The audio controller 122 may include an input selector 124 configured to provide audio content from a selected audio source 126 to an audio amplifier 128 for playback through vehicle speakers 130. The audio sources 126 may include, as some examples, decoded amplitude modulated (AM) or frequency modulated (FM) radio signals, and compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a grammar of available commands, and voice prompt generation for output via the audio controller 122. In some cases, the system may be configured to temporarily mute, fade, or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke computing platform 104 functions (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, or a media oriented system transfer (MOST), as some examples. The in-vehicle networks 142 may allow the computing platform 104 to communicate with other vehicle 102 systems, such as an vehicle modem 144 (which may not be present in some configurations), a global positioning system (GPS) controller 146 configured to provide current vehicle 102 location and heading information, and various vehicle controllers 148 configured to provide other types of information regarding the systems of the vehicle 102. As some non-limiting possibilities, the vehicle controllers 148 may include a powertrain controller configured to provide control of engine operating components (e.g., idle control components, fuel delivery components, emissions control components, etc.) and monitoring of engine operating components (e.g., status of engine diagnostic codes); a body controller configured to manage various power control functions such as exterior lighting, interior lighting, keyless entry, remote start, and point of access status verification (e.g., closure status of the hood, doors, and/or trunk of the vehicle 102); a radio transceiver configured to communicate with key fobs or other local vehicle 102 devices; and a climate control management controller configured to provide control and monitoring of heating and cooling system components (e.g., compressor clutch and blower fan control, temperature sensor information, etc.).

As shown, the audio controller 122 and the HMI controls 136 may communicate with the computing platform 104 over a first in-vehicle network 142A, and the vehicle modem 144, GPS controller 146, and vehicle controllers 148 may communicate with the computing platform 104 over a second in-vehicle network 142B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a Bluetooth® controller, a ZigBee® transceiver, a Wi-Fi transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The wide-area network 156 may provide communications services, such as packet-switched network services (e.g., Internet access, VoIP communication services), to devices connected to the wide-area network 156. An example of a wide-area network 156 may include a cellular telephone network. Mobile devices 152 may provide network connectivity to the wide-area network 156 via a device modem 158 of the mobile device 152. To facilitate the communications over the wide-area network 156, mobile devices 152 may be associated with unique device identifiers (e.g., media access control (MAC) addresses, mobile device numbers (MDNs), Internet protocol (IP) addresses, mobile station international subscriber directory numbers (MSISDNs), international mobile subscriber identity (IMSI), etc.) to identify the communications of the mobile devices 152 over the wide-area network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, secret information shared between the paired mobile device 152 and the computing platform 104 such as link keys, and/or personal identification numbers (PINs), and most recently used or device priority information, such that the computing platform 104 may automatically reconnect to the mobile devices 152 matching data in the paired device data 160 without user intervention. In some cases, the paired device data 160 may also indicate additional information or options related to the permissions or functionality of the computing platform 104 that the paired mobile device 152 is authorized to access when connected.

When a paired mobile device 152 that supports network connectivity is automatically or manually connected to the computing platform 104, the mobile device 152 may allow the computing platform 104 to use the network connectivity of the device modem 158 to communicate over the wide-area network 156. In one example, the computing platform 104 may utilize a data-over-voice connection over a voice call or a data connection of the mobile device 152 to communicate information between the computing platform 104 and the wide-area network 156. Additionally or alternately, the computing platform 104 may utilize the vehicle modem 144 to communicate information between the computing platform 104 and the wide-area network 156, without use of the communications facilities of the mobile device 152.

Similar to the computing platform 104, the mobile device 152 may include one or more processors 162 configured to execute instructions of mobile applications 168 loaded to a memory 164 of the mobile device 152 from storage medium 166 of the mobile device 152. In some examples, the mobile applications 168 may be configured to communicate with the computing platform 104 or other locally-networked devices and with the wide-area network 156.

The computing platform 104 may also include a device link interface 170 to facilitate the integration of functionality of the mobile applications 168 into the grammar of commands available via the voice interface 134. The device link interface 170 may also provide the mobile applications 168 with access to vehicle features, such as information available to the computing platform 104 via the in-vehicle networks 142 or access to the display 138. An example of a device link interface 170 may be the SYNC APPLINK component of the SYNC system provided by The Ford Motor Company of Dearborn, Mich.

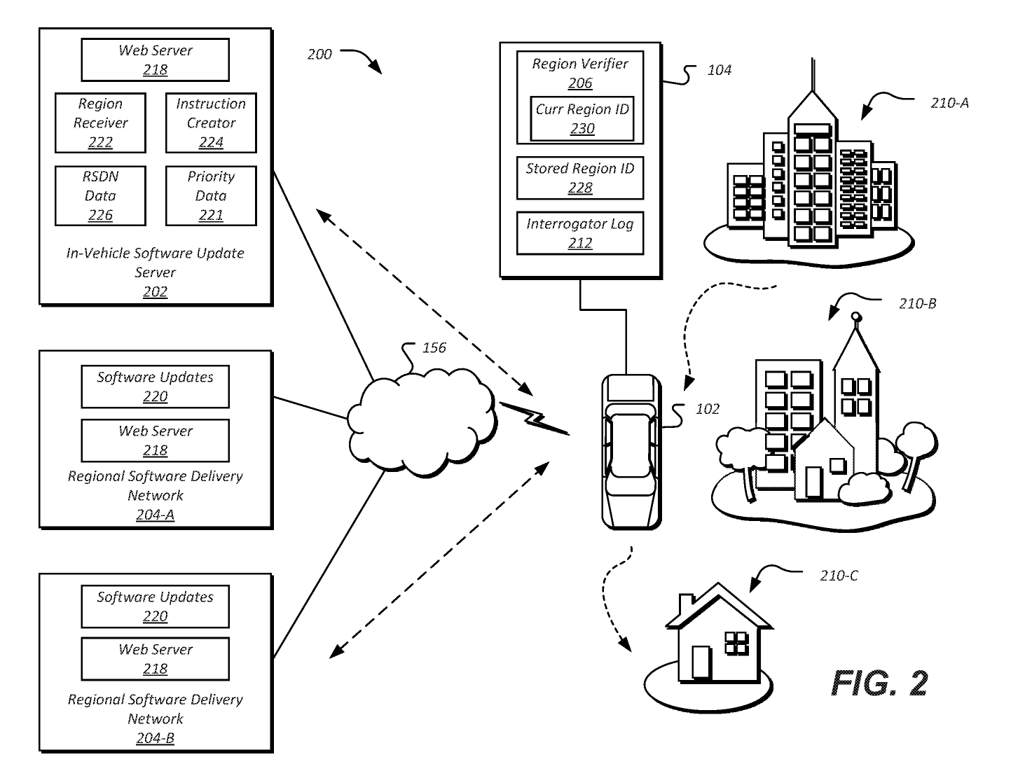

FIG. 2 is an exemplary diagram of a system 200 including an in-vehicle software update server (hereinafter, IVSU) 202 and multiple regional software delivery networks 204 in communication over the network 156 with the vehicle 102. The vehicle 102 may be in wireless communication with the network 156 by way of the computing platform 104 of the vehicle 102. When the vehicle 102 is assembled, the vehicle 102 may include various hardware and software components. Upon or after assembly, the computing platform 104 of the vehicle 102 may be configured to query for existence and version information for at least a portion of these hardware and software components of the vehicle 102. The computing platform 104 may, for instance, reference an optimized data identifier list (ODL) file 214 that defines the specific information to query and where such information may be located. The ODL file 214 may, in some cases, be installed as part of an installation of software on the computing platform 104.

The computing platform 104 may use the queried data to generate an interrogator log 212. The interrogator log 212 may be a file or other data structure including information collected from the vehicle 102 for use in identifying the current software version state of the vehicle 102. The interrogator log 212 may include information identifying the specific vehicle 102 as well as one or more of the vehicle controllers 148 using parameters and values such as, but not limited to, controller name, controller serial number, VIN, hardware part number, MAC address, part numbers of software applications, languages, and service packs installed on the controller, available storage space on the controller, and status information regarding the installation of previous updates.

The computing platform 104 may be further configured to query for a stored region identifier 228. The stored region identifier 228 may be an alpha-numeric identifier of a region 210 where the vehicle 102 was manufactured, assembled, or tested or, instead, a region 210 intended for distribution of the vehicle 102 to a customer. The region 210 may thus be a geographic region associated with the vehicle 102 and may, but need not, correspond to political boundaries, international, national, or local borders designating sovereign territories, provinces, principalities, or other settlement types. As described below, responsive to the vehicle 102 changing regions 210, the stored region identifier 228 may be updated to match a region identifier of the region 210 in which the vehicle 102 is currently located.

Using information identifying the specific vehicle 102, such as, but not limited to, vehicle identification number (VIN) information published on the car area network (CAN) bus, subscriber identity module (SIM) information of the vehicle modem 144 such as international mobile station equipment identity (IMEI), the computing platform 104 may communicate with the IVSU 202 via the network 156 to establish an account. In an example, the computing platform 104 may send the IVSU 202 the interrogator log 212 that includes information identifying the specific vehicle 102 and information related to a current software version of the controllers of the vehicle 102. The IVSU 202 may receive these communications from the vehicles 102, and may maintain a data store of the hardware configurations and software (e.g., firmware, etc.) versions linked to identifiers of the vehicles 102, e.g., linked to VIN of the vehicle 102. The IVSU 202 may further maintain a data store of the stored region identifier 228 defining the previously-determined region 210 associated with the vehicle 102.

The regional software delivery networks 204 may be located in different regions 210, such that each of the regions 210 has its own corresponding regional software delivery network 204. Each regional software delivery network 204 may provide one or more web servers 218 for hosting software updates 220 for download by the vehicles 102. The web servers 218 may include one or more devices configured to serve the software updates 220 stored by the regional software delivery network 204 to the vehicles 102. For example, the web servers 218 may be configured to receive the update requests for available software updates 220 from vehicles 102. In an example, the regional software delivery networks 204 may be intended to serve the software updates 220 to vehicles 102 in the same region 210 as the regional software delivery network 204.

The software updates 220 may include changes to the software or settings of the vehicle 102 to address an issue with the current software or settings, or to provide improved functionality to the current software. The software updates 220 may include, for example, updated configuration settings for the one or more vehicle controllers 148, and/or updated versions of software or firmware to be installed on the one or more vehicle controllers 148. In some cases software updates 220 may include a single section, while in other cases software updates 220 may be organized into multiple subsections, partitions, or chunks, where all the subsections may be downloaded to complete the overall software update 220 to be installed. In some examples, the software updates 220 may be originated by a vendor (e.g., of the vehicle controllers 148) or originated by the vehicle manufacturer. In some cases, at least a portion of the software updates 220 may be encrypted, while in other cases the software updates 220 may be unencrypted.

Each software update 220 may be associated with priority data 221. In an example, the IVSU 202 may maintain an association of software updates 220 to corresponding priority data 221. The priority data 221 may indicate which software updates 220 to push to a vehicle 102 and in what order. For instance, an engineer may assign a priority to each software release available for download based on the fix or other functionality embodied by the software update 220. The engineer may also be able to assign a priority preference of the software update 220 per vehicle 102 (e.g., according to vehicle VIN). This may be used by the engineer to push a software update 220 that is not mandatory as a high priority software update 220 for that specific vehicle 102. On the vehicle 102 side, a customer may be able to pay for a specific software update 220, thereby increasing the priority of the paid software update 220. Additionally or alternatively, the customer may have the ability to overwrite the priority and time of the software update 220 that will provided for download. These priorities may be maintained in the priority data 221 of the IVSU 202.

As an example set of priorities included in the priority data 221, a Priority 1 update may indicate a Mandatory fix (e.g., for any software updates 220 that are fixing issues that the government would require a recall), a Priority 2 update may indicate that the customer has paid for the software update 220, a Priority 3 update may indicate a software update 220 to fix noticeable issues in one or more features, a Priority 4 may indicate a software update 220 to provide new features to customers, a Priority 5 update may indicate a software update 220 to fix unnoticeable issues, a Priority 6 update may indicate a preferred software update 220, and a Priority 7 update may indicate a non-imminent software update 220 to be scheduled at a customer-specific time.

The region verifier 206 may be implemented as software and/or firmware executed by one or more processors of the computing platform 104. The region verifier 206 of the vehicle 102 may be configured to determine in which region 210 the vehicle 102 is currently located. In an example, the region verifier 206 may be configured to retrieve information indicative of the current location of the vehicle 102 from the GPS controller 146 and/or from one or more of the vehicle controllers 148. For instance, the region verifier 206 may be configured to retrieve the current location of the vehicle 102 periodically or in response to a predefined signal, e.g., at every ignition cycle/starting event and/or at every predefined number of ignition cycles/starting events. The region verifier 206 may be further configured to determine to which of the regions 210 the current location of the vehicle 102 corresponds. The region verifier 206 may, for instance, reference a listing of region identifiers stored in the memory 108 and linked to a plurality of geographic coordinates identifying the boundaries of the regions 210, such as by way of geofence GPS coordinates.

Responsive to the determination of the current region 210 of the vehicle 102, the region verifier 206 may be configured to compare the current region identifier 230 corresponding to the identified current region 210 of the vehicle 102 to a stored region identifier 228 indicating a previously-determined region 210 in which the vehicle 102 was located. In an example, the stored region identifier 228 may be maintained by the region verifier 206 in a data store of the computing platform 104. Responsive to the region verifier 206 determining that the current region identifier 230 is different from the stored region identifier 228, the region verifier 206 may be configured to transmit the current region identifier 230 to the IVSU 202. In one example, the region verifier 206 may be configured to send the current region identifier 230 in response to determinations that the current region identifier 230 continues to be different from the stored region identifier 228 for a predefined period of time or a predefined number of ignition cycles/starting events. If so, the region verifier 206 may be configured to update the stored region identifier 228 in the data store with an identifier of the current region identifier 230, prior to, during, or in response to transmission of the current region identifier 230 to the IVSU 202.

A region receiver 222 may be implemented as software and/or firmware executed by one or more processors of the IVSU 202. The region receiver 222 of the IVSU 202 may be configured to receive a message from the vehicle 102 identifying the vehicle 102 (e.g., by VIN) and indicating the current region identifier 230 of the vehicle 102. This may accordingly allow the IVSU 202 to be informed of the region 210 in which the vehicle 102 is presently located. The region receiver 222 may be configured to associate the received current region identifier 230 with information identifying the specific vehicle 102, e.g., VIN, for use in processing update requests from the vehicle 102. For instance, responsive to an update request, the region receiver 222 may be configured to identify the current region identifier 230 corresponding to the VIN of the vehicle 102 sending the request, such as the current region identifier 230 received from the same vehicle 102 during a prior data exchange.

The region receiver 222 may use regional software delivery network (RSDN) data 226 to determine which of the regional software delivery networks 204 is to be used by the vehicle 102 requesting the software updates 220. In an example, the region receiver 222 may use the information maintained in the data store to identify which regional software delivery network 204 is intended to serve the software updates 220 for a vehicle 102 located in the current region identifier 230. The RSDN data 226 may include information indicating which regional software delivery networks 204 are allocated for use in which regions 210. In an example, the RSDN data 226 may include a mapping of network identifiers or other addresses of the regional software delivery networks 204 to identifiers of the regions 210 served by the respective regional software delivery networks 204.

It should be noted that other approaches to determining the region 210 of the vehicle 102 may be utilized. For instance, the IVSU 202 may determine a location for the vehicle 102 based on an origination address (e.g., Internet protocol (IP address) of a connection over which the vehicle provided the interrogator log 212. The IVSU 202 may include information indicating which regional software delivery networks 204 are allocated for use in which regions 210. Using the origination address, the IVSU 202 may derive the country or region 210 in which the vehicle 102 is located. In an example, the IVSU 202 may include a mapping of IP or other addresses of the regional software delivery networks 204 to identifiers of regions served by the respective regional software delivery networks 204.

Separately or in combination with the region receiver 222, an instruction creator 224 may be implemented as software and/or firmware executed by one or more processors of the IVSU 202. The instruction creator 224 may be configured to generate an instruction file (hereinafter, instructions) 216 using the interrogator log 212. To identify the software updates 220, the instruction creator 224 may be configured to compare the current software versions of controllers indicated in the interrogator log 212 received from the vehicle 102 with the latest version of the software compatible with the computing platform 104. The instruction creator 224 may be further configured to identify, for any components that should be updated, any additional dependencies that those updated versions may require. Those additional dependencies may further be added to the instructions 216 sent to the vehicle 102. Based on the regional software delivery network 204 intended to serve the software updates 220 identified by the region receiver 222, the instruction creator 224 may populate the download locations in the instructions 216 with network locations served by web servers 218 of the one of the regional software delivery networks 204 in the region associated with the vehicle 102.

Rather than providing vehicles 102 with software updates 220 in a FIFO manner, the instruction creator 224 may be further configured to utilize the priority data 221 to determine an ordering of software updates 220 for the vehicle 102. In an example, the instruction creator 224 may be configured to include mandatory software updates 220 (e.g., priority 1) and paid software updates (e.g., priority 2) in the instructions 216, while allowing unnoticeable (e.g., priority 5) or non-imminent updates (e.g., priority 7) to be scheduled later (e.g., at a customer-specified time).

In some cases, the priority data 221 may be keyed to region identifier in addition to priority. For instance, in some cases the priority of a software update 220 may vary according to the region in which the vehicle 102 is located. In an example, a software update 220 may indicate an update to provide new features to customers (e.g., priority 4) in one region, but may be mandated by a government for inclusion in the vehicle 102 in another region, and may therefore in that other region the software update 220 may be a mandatory priority 1 update.

The instructions 216 may be a file or other data structure configured to identify binaries or other software updates 220 that should be installed to the vehicle 102. The instructions 216 may specify network locations at which each of the specified software updates 220 may be retrieved. As one example, the instructions 216 may specify the network locations as universal resource locators (URLs) served by web servers 218 of the one of the regional software delivery networks 204 in the region 210 associated with the vehicle 102.

The network locations defined in the instructions 216 may vary from one another based on the region 210 with which they are associated. In one example, the network locations designating an update for one of the regional software delivery networks 204 may differ from network locations for the same update on another one of the regional software delivery networks 204. Additionally, the content of the software update files served by the regional software delivery networks 204 may vary based on the region 210. In an example, the instructions 216 may include the network locations for region-specific update files served by web servers 218 of the one of the regional software delivery networks 204 to the vehicles 102 being associated with the region 210.

The region-specific update files may include, but are not limited to, files defining requirements, restrictions, specifications, regulations, and other characteristics unique to one or more regions 210. In an example, the region-specific update files may include specifications related to one or more aspects of operating, owning, and/or storing the vehicle 102, such as, but not limited to, emissions, lighting, climate control, and fuel-efficiency. As one example, in certain regions 210 in-dash lighting intensity may be required to be set at a maximum, while in other regions 210 the software may offer user configuration of lighting intensity. As another example, in certain regions 210 vehicle headlights may be required to turn on during the operation of windshield wipers while in other regions 210 such a requirement may not exist. As still another example, limited navigation display operation may be permissible at low speeds in certain regions 210 while in other regions 210 the display may be required to be automatically disabled when the vehicle 102 is shifted out of PARK gear.

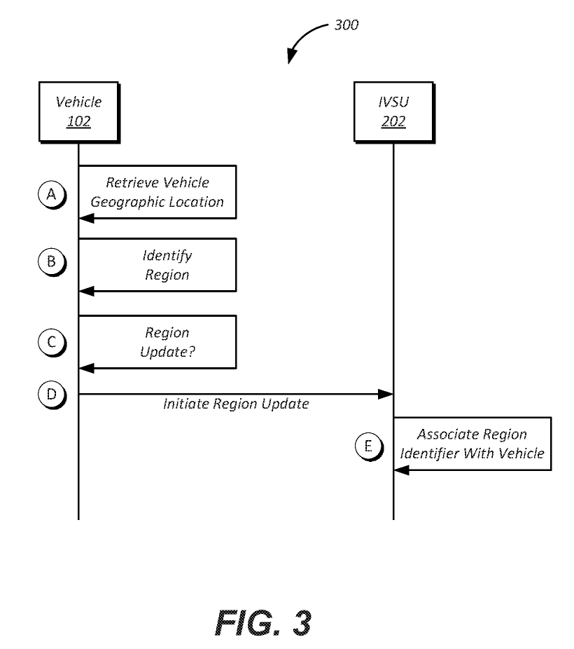

FIG. 3 illustrates an example data flow diagram 300 illustrating the update of a region identifier associated with the vehicle 102 based on the region 210 in which the vehicle 102 is located. In an example, the data flow may be performed using a system such as illustrated in FIG. 2.

At time index (A), the computing platform 104 retrieves information related to a current location of the vehicle 102. The region verifier 206 may, for example, retrieve geographic coordinates from the GPS controller 146 indicating a location of the vehicle 102 at each ignition cycle/starting event. At time index (B), the computing platform 104 identifies which region 210 corresponds to the current location of the vehicle 102. In an example, the computing platform 104 may reference a listing of region identifiers stored in the memory 108 and linked to a plurality of geographic coordinates identifying the boundaries of the regions 210, such as by way of geofence GPS coordinates.

At time index (C), the computing platform 104 compares the current region identifier 230 to the stored region identifier 228 maintained in the data store to determine whether a region update of the IVSU 202 is required. At time index (D), the computing platform 104 sends a message to the IVSU 202 in response to determining, at time index (C), that that the current region identifier 230 is different from the stored region identifier 228. In one example, the region verifier 206 sends a message to the IVSU 202 including the current region identifier 230 in response to determining, at time index (D), that the current region identifier 230 is consistently different from the stored region identifier 228 for a predefined period of time or a predefined number of ignition cycles/starting events. The IVSU 202, at time index (E), associates the current region identifier 230 indicated in the received message with the vehicle 102 in the data store.

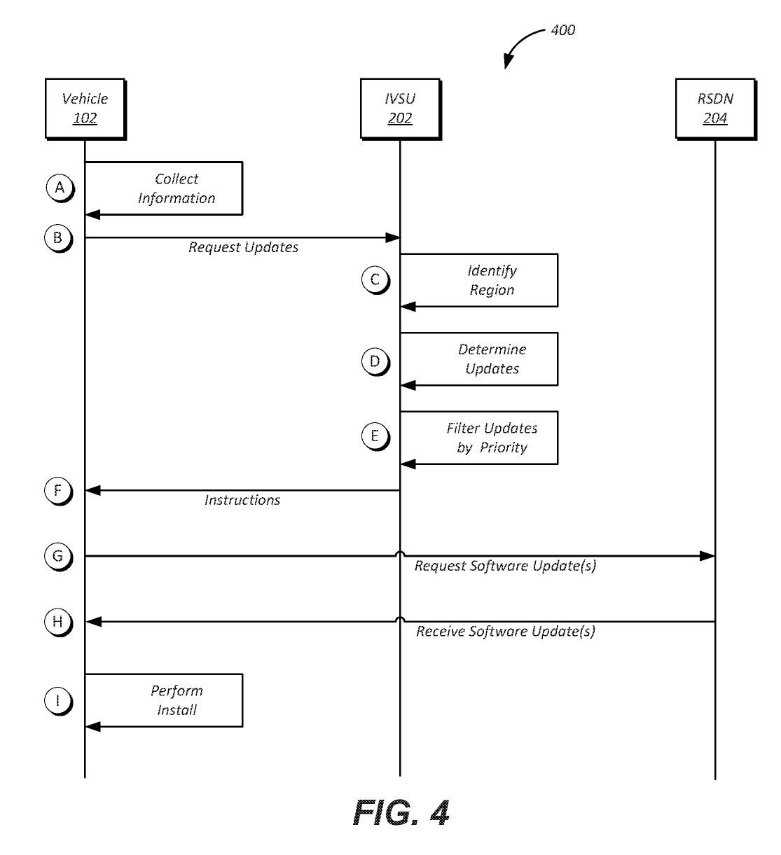

FIG. 4 is an example data flow 400 illustrating performing a region-specific update based on a region identifier associated with the vehicle 102 is shown. At time index (A), the computing platform 104 collects information related to the controllers of the vehicle 102. The process of collecting data may be referred to as interrogation, and the collected data may be referred to as the interrogator log 212. In an example, a user of the vehicle 102 may opt into download of the software updates 220 via a prompt immediately prior to update download or may have previously authorized automatic hardware and software updates. Once authorized (e.g., by way of receiving button presses or spoken dialog from the user), the computing platform 104 may be configured to query for software updates 220 for the vehicle controllers 148. This querying may be performed silently, without requiring user input.

The computing platform 104 may determine what information to collect using the ODL file 214. Notably, the information to collect may include data elements from the vehicle controllers 148 or other controllers of the vehicle 102, and may be retrieved via the controller area network (CAN) or other vehicle 102 communication architecture supporting data transfer between controllers. The information may also include diagnostic codes and other vehicle state information that may be collected during vehicle 102 servicing by a dealer. The information may also include analytics data including usage and logging data providing insight into usage of various vehicle features. In some cases, the ODL file 214 may be installed as part of an installation of software on the computing platform 104, while in other cases the ODL file 214 may have been previously received according to earlier performed updates.

At time index (B), the computing platform 104 sends an update request, e.g., sends the interrogator log 212, to the IVSU 202. In an example, the computing platform 104 may send the interrogator log 212 to the IVSU 202 via HTTPS (e.g., by connection of the computing platform 104 to a predefined web address of the IVSU 202 known to the computing platform 104). The IVSU 202, accordingly, may receive the interrogator log 212 from the web.

At time index (C), the IVSU 202 determines the region 210 associated with the vehicle 102 based on the current region identifier 230 maintained in the data store in association with an identifier of the vehicle 102. Using the current region identifier 230 and the RSDN data 226, the region receiver 222 of the IVSU 202 may determine which regional software delivery network 204 is intended to serve the software updates 220 for the vehicle 102. It should be noted that other approaches to determining the region of the vehicle 102 may be utilized. For instance, using the originating address and stored data, the region receiver 222 of the IVSU 202 may derive the originating country or region for the update request based on the originating address of the request.

In response to identifying the regional software delivery network 204, the IVSU 202 determines the software updates 220 at time index (D). In an example, the IVSU 202 reviews the current controller configuration and current version of the computing platform 104, and identifies software update 220 binaries that should be installed on the vehicle 102.

At time index (E), the IVSU 202 filters the determined software updates 220 according to the priority data 221. In an example, the instruction creator 224 filter the determined software updates 220 to include mandatory software updates 220 (e.g., priority 1) and paid software updates (e.g., priority 2) in the instructions 216, while filtering out unnoticeable (e.g., priority 5) or non-imminent updates (e.g., priority 7) to be scheduled later (e.g., at a customer-specified time). In some cases, the priority data 221 may be keyed to region identifier in addition to priority. For instance, in some cases the priority of a software update 220 may vary according to the region in which the vehicle 102 is located. In an example, a software update 220 may indicate an update to provide new features to customers (e.g., priority 4) in one region, but may be mandated by a government for inclusion in the vehicle 102 in another region, and may therefore in that other region the software update 220 may be a mandatory priority 1 update.

The IVSU 202 creates the instructions 216 according to the filtered software updates 220 and sends the instructions 216 to the vehicle 102 at time index (F). In an example, the instruction creator 224 of the IVSU 202 may populate the download locations in the instructions 216 with region-specific network locations for the regional software delivery network 204 intended to serve the region 210. In another example, the instruction creator 224 may generate the instructions 216 including the network locations for region-specific update files served by the web servers 218 of the regional software delivery network 204 to the vehicles 102 being associated with the current region identifier 230 defining the region 210 where the vehicle 102 is now located.

The software updates 220 to be installed may be identified in the instructions 216. Moreover, the instructions 216 may specify network locations at which each of the specified update binaries may be retrieved. As one example, the instructions 216 may specify the network locations as URLs served by a web server 218 of the IVSU 202. In some cases, the software updates 220 may include new versions of files to be installed, while in other cases, the software updates 220 may include incremental updates to be applied to currently installed files to update the currently-installed files from one version to a next version.

In an example, the IVSU 202 may send the instructions 216 to the vehicle 102 via HTTPS (e.g., over the HTTPS connection to which the computing platform 104 sent the interrogator log 212 to the computing platform 104, over a different connection to the same or a different predefined web address of the IVSU 202 known to the computing platform 104, etc.). Once received, the computing platform 104 may be configured to install the software updates 220 indicated by the instructions 216.

Based on the instructions 216, at time index (G) the computing platform 104 requests the software updates 220 (e.g., configuration files, binaries, etc.) from the link locations specified by the instructions 216. In one example, the computing platform 104 may request the updates from region-specific network locations for the regional software delivery network 204 intended to serve the region 210. In another example, the computing platform 104 may request the region-specific update files from the link locations specified by the instructions 216.

The computing platform 104 may accordingly download the software updates 220 as shown at time index (H). As one example, the instructions 216 may specify the network locations as URLs served by a web server 218 of the IVSU 202, and the computing platform 104 may download the software update 220 from the URLs specified by the instructions 216. As the software updates 220 may be made available from the web server 218 via HTTPS, the computing platform 104 may be able to download the software updates 220 using resume functionality available for downloads from web servers 218.

At time index (I), the computing platform 104 installs the downloaded software updates 220. In some examples, to avoid disruption of the current version of software installed to the computing platform 104, the computing platform 104 may be configured to perform the installation to a second installation of the computing platform 104, other than the currently active installation from which the computing platform 104 was booted. The installation of the updates to the second installation may be performed silently, without requiring input from the user.

Upon completion of installation of the software updates specified by the instructions 216, the computing platform 104 may be configured to perform an additional interrogation of the controllers of the vehicle 102 to create a new interrogator log 212. The computing platform 104 may subsequently create the interrogator log 212, e.g., using the received ODL 214, providing an updated definition of what information to interrogate for the currently performed software updates 220. The computing platform 104 may be configured to send the interrogator log 212 to the IVSU 202, e.g., via HTTPS. Accordingly, the IVSU 202 may be automatically updated with the installation status of the vehicle 102, without requiring user HMI interaction.

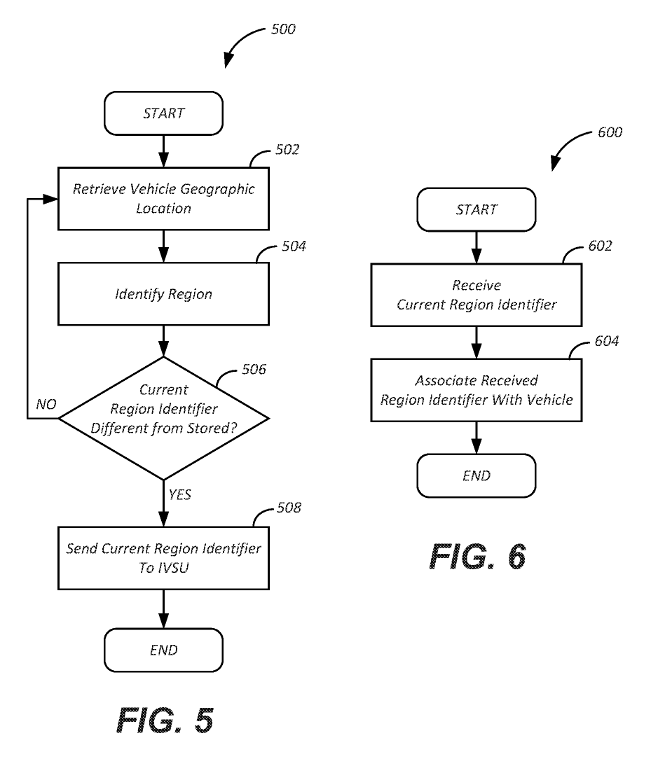

FIG. 5 illustrates an example process 500 for updating software of the computing platform 104 using a regional software delivery network 204. The process 500 may be performed, for example, by the computing platform 104 of the vehicle 102 in communication with the IVSU 202 and the regional software delivery network 204 over the network 156.

At operation 502, the computing platform 104 retrieves a current location of the vehicle 102. In one example, the computing platform 104 may retrieve the current location of the vehicle 102 from the GPS controller 146 and/or one or more of the vehicle controllers 148. In another example, the computing platform 104 may retrieve location of the vehicle 102 periodically or in response to a predefined signal, e.g., at every ignition cycle/starting event and/or every predefined number of ignition cycles/starting events. The computing platform 104, at operation 504, determines to which of the regions 210 the location of the vehicle 102 corresponds. The computing platform 104 may also determine the current region identifier 230 by referencing a listing of region identifiers stored in the memory 108 and linked to a plurality of geographic coordinates identifying the boundaries of the regions 210, such as by way of geofence GPS coordinates.

At operation 506, the computing platform 104 determines whether the current region identifier 230 corresponding to the region 210 where the vehicle 102 is currently located is different from the stored region identifier 228 corresponding to the previously-determined region 210. The control passes to operation 502 where the computing platform 104 retrieves a location of the vehicle 102 in response to determining, at operation 506, that the current region identifier 230 corresponding to the region 210 is the same as the stored region identifier 228 associated with the vehicle 102.

The computing platform 104, at operation 508, sends the current region identifier 230 to the IVSU 202 in response to determining, at operation 506, that the current region identifier 230 is different from the stored region identifier 228. In an example, the computing platform 104 may send the current region identifier 230 in response to the current region identifier 230 being consistently different from the stored region identifier 228 for a predefined period of time or a predefined number of ignition cycles. After operation 508, control passes to operation 502.

FIG. 6 illustrates an example process 600 for updating a region identifier associated with the vehicle 102 in a data store of the IVSU 202. The process 600 may be performed, for example, by the IVSU 202 in communication with the vehicle 102 and the regional software delivery network 204 over the network 156.

At operation 602, the IVSU 202 receives a message from the vehicle 102 indicating the current region identifier 230 defining the region 210 in which the vehicle 102 is located. At operation 604, the IVSU 202 associates the received current region identifier 230 with the vehicle 102 for use with update requests from the vehicle 102. After operation 604, the process 600 ends.

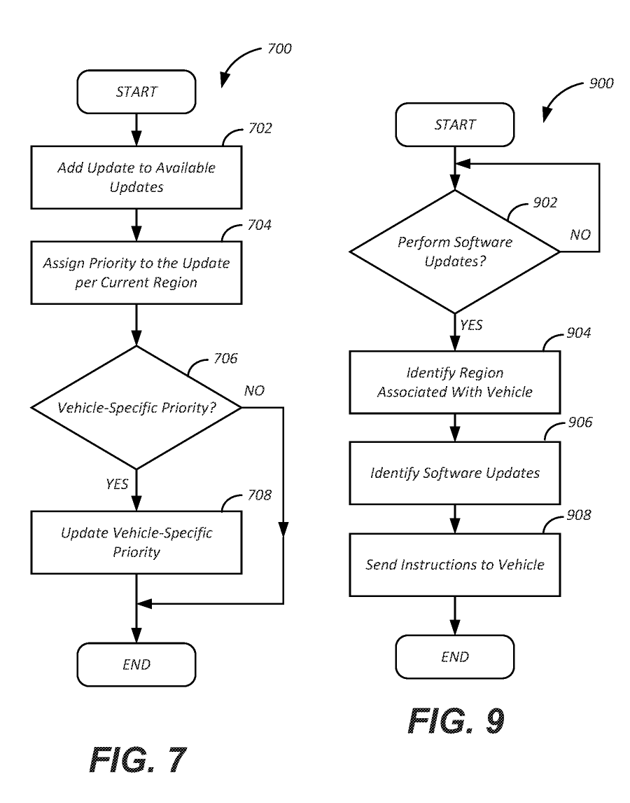

FIG. 7 illustrates an example process 700 for updating software updates 220. In an example, the process 700 maybe performed by the IVSU 202 in the context of the system 200, described in detail above.

At operation 702, the IVSU 202 adds a software update 220 to the software updates 220 available for the vehicles 102. At operation 704, the IVSU 202 assigns a priority to the software update 220. In an example, the software update 220 may include or be received in association with metadata specifying the priority of the software update 220. In some examples, the priority may be consistent across regions. In other examples, the priority varies according to region. Regardless of the specific priority or priorities, the IVSU 202 may store the priority information in the priority data 221.

At operation 706, the IVSU 202 determines whether there is a vehicle-specific priority for the software update 220. In an example, the user may have paid for the software update 220 to increase the priority of the software update 220 in association with the VIN of the user's vehicle 102. If so, control passes to operation 708, in the IVSU 202 updates the priority data 221 to indicate the priority specific to the vehicle 102. Otherwise, and after operation 708, the process 700 ends.

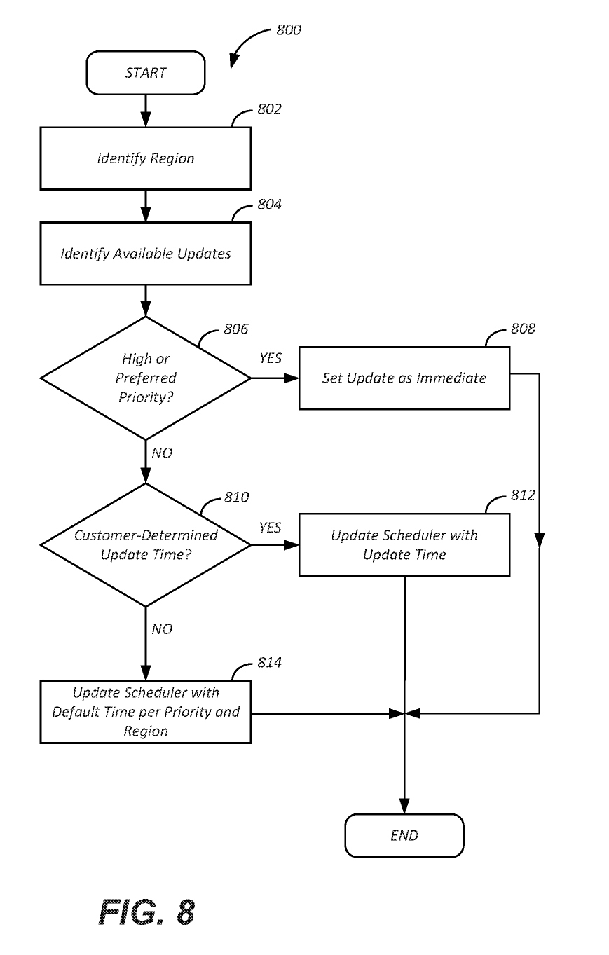

FIG. 8 illustrates an example process 800 for determining software updates 220 for a vehicle 102. In an example, the process 800 may be performed by the IVSU 202 in the context of the system 200, described in detail above. The process 800 may be initiated, for example, responsive to addition of new software updates 220 to the IVSU 202 (or the updating of priority of existing software updates 220) as discussed above with respect to the process 700.

At operation 802, the IVSU 202 identifies the region of the vehicle 102. In an example, as discussed above with respect to time index (C) of the data flow 400, the IVSU 202 determines the region 210 associated with the vehicle 102 based on the current region identifier 230 maintained in the data store in association with an identifier of the vehicle 102. In another example, the region receiver 222 of the IVSU 202 may derive the originating country or region for the update request based on the origination address (e.g., Internet protocol (IP) address) of a connection over which the vehicle 102 most recently connected to the IVSU 202.

At operation 804, the IVSU 202 identifies an available software update 220 for the vehicle 102. In an example, as discussed above with respect to time index (D) of the data flow 400, the IVSU 202 reviews the current controller configuration and current version of the computing platform 104, and identifies a software update 220 that should be installed on the vehicle 102.

At operation 806, the IVSU 202 determines whether the available software update 220 is of a high or preferred priority. In an example, the IVSU 202 may identify which of the available software updates 220 for the vehicles 102 include mandatory software updates 220 (e.g., priority 1) and paid software updates (e.g., priority 2). In another example, the IVSU 202 may further identify Priority 3 updates indicating a software update 220 to fix noticeable issues in one or more features as being of high or preferred priority. In yet another example, the IVSU 202 may additionally or alternatively identify Priority 4 software updates 220 indicating a software update 220 to provide new features to customers as being of high or preferred priority. Regardless of the specific priorities chosen, if the software updates 220 is of a high or preferred priority, control passes to operation 808.

At operation 808, the IVSU 202 sets the identified software updates 220 as being for immediate update. Accordingly, the vehicle 102 may receive instructions 216 to install the software update 220.

At operation 810, the IVSU 202 determines whether a customer-determined update time is set for the software updates 220. In an example, a customer may have user-specific settings stored to the IVSU 202 that indicate when the vehicle 102 of the user is indicated as being ready to receive software updates 220. If so, control passes to operation 812 to update the scheduler of the IVSU 202 with that update time to provide the instructions 216 to the vehicle 102 to initiate installation of the software update 220. After operation 812, the process 800 ends.

If no customer-determined update time is specified, control passes to operation 814 to update the scheduler of the IVSU 202 with a default update time to provide the instructions 216 to the vehicle 102. The IVSU 202 may determine the default time, for example, based on the priority of the update and/or based on the region in which the vehicle 102 is located. After operation 814, the process 800 ends.

FIG. 9 illustrates an example process 900 for providing instructions 216 to the vehicle 102. In an example, the process 900 may be performed by the IVSU 202 in the context of the system 200, described in detail above.

At operation 902, the IVSU 202 determines whether to perform providing of software updates 220. In an example, the IVSU 202 may receive a request from the computing platform 104 of a vehicle 102 requesting the IVSU 202 to provide software updates 220. This request may have been sent by the vehicle 102 in response to the vehicle 102 determining that a trigger has occurred to request software updates 220. For instance, upon determining that a predetermined number of key-on cycles have been completed by the vehicle 102 and/or a predetermined amount of time has elapsed, and further that a network connection is available to communicate to the IVSU 202 (e.g., via a connected mobile device 152), the computing platform 104 may determine that the vehicle 102 should check for software updates. As previously described in reference to at least FIGS. 2 and 4, the vehicle 102 may include the interrogator log 212 with the request to the IVSU 202 for the software updates 220. The interrogator log 212 may include version information of at least one software controller installed on the vehicle 102, as well as, but not limited to, controller name, controller serial number, VIN, hardware part number, MAC address, part numbers of software applications, languages, and service packs installed on the controller, available storage space on the controller, and status information regarding the installation of previous updates. In some cases, the computing platform 104 may generate the interrogator log 212 according to an ODL 214 defining what information to interrogate and where such information may be located.

In another example, the scheduler of the IVSU 202 may determine based on a previous request for updates that lower-priority updates are now scheduled to be provided to the vehicle 102. When the previously determined update is scheduled, the IVSU 202 may utilize saved information from the vehicles 102 to complete the process, such as a saved interrogator log 212 previously provided to the IVSU 202 during a previous update request or completion message.

If software updates 220 are indicated, control passes to operation 904. Otherwise, control remains at operation 902.

At 904, the IVSU 202 identifies a region identifier associated with the vehicle 102 that requested the software updates 220. In one example, the IVSU 202 may use vehicle information included with the interrogator log 212, such as, for example, VIN, to locate the vehicle 102 in the data store. The IVSU 202 may further reference the data store to identify a region identifier associated with the vehicle 102 that requested the software updates 220.

At operation 906, the IVSU 202 identifies the software updates 220 for the vehicle 102. Details of the determination of software update 220 are described above with respect to the process 800.

The IVSU 202, at operation 908, provides instructions 216 to the vehicle 102 according to the determined software updates 220. The instructions 216 may include information identifying which of the regional software delivery networks 204 is intended to serve the software updates 220 for a vehicle 102 based on a region identifier of the region 210 associated with the vehicle 102. The instructions 216 may further indicate one or more binaries to be downloaded and installed by the vehicle 102, as well as other information to use when performing the update, such as updated ODL 214 and/or keys to decrypt the binaries to be downloaded and installed.

The network locations defined in the instructions 216 may vary from one another based on the region 210 with which they are associated. In one example, the network locations designating an update for one of the regional software delivery networks 204 may differ from network locations for the same update on another one of the regional software delivery networks 204. Additionally, the content of the software update files served by the regional software delivery networks 204 may vary based on the region 210. In an example, the instructions 216 may include the network locations for region-specific update files served by the web servers 218 of the one of the regional software delivery networks 204 to the vehicles 102 being associated with the region 210. After operation 610, control passes to operation 602.

Responsive to the receipt of the instructions 216, the vehicle 102 may download the software updates 220 specified by the instructions 216, such as, by downloading the software updates 220 from the web server 218 of the regional software delivery network 204 network locations specified by the instructions 216. Upon download completion, the computing platform 104 may install the software updates 220, such as by executing or otherwise applying the firmware update to the installed firmware version to update the firmware version. In some cases, the computing platform 104 may send a message to the IVSU 202 to alert the IVSU 202 of success or failure of installation of the software updates 220. Upon receiving a message indicating success of the software update, the IVSU 202 may update its records of the installed configuration status of the vehicle 102.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system comprising:
a server configured to:
access stored priority data to determine a priority of a software update specific to a vehicle to be updated,
responsive to the priority indicating that the software update is an add-on authorized for use by the vehicle, schedule the software update for immediate push, and
otherwise, schedule the software update to the vehicle at a time according to the priority and a geographic region of the vehicle.

2. The system of claim 1, wherein the server is further configured to, responsive to a vehicle request for software updates, indicate that the software update is provided by a regional software delivery network located within the geographic region of the vehicle.

3. The system of claim 1, wherein the server is further configured to:
receive, from the vehicle responsive to vehicle presence in the geographic region for a predefined period, a message indicating the geographic region in which the vehicle is located,
responsive to the message, update a data store to associate the vehicle with the geographic region.

4. The system of claim 3, wherein the server is further configured to update the data store to indicate that the vehicle is associated with the geographic region using a vehicle identification number (VIN) of the vehicle included in the message.

5. The system of claim 1, wherein the geographic region corresponds to a political boundary.

6. The system of claim 1, wherein the priority includes one or more of: a first priority indicating a mandatory fix, a second priority indicating that the vehicle is paid for the software update, a third priority indicating a software update to fix functional issues in one or more features, a fourth priority indicating a software update to provide new features, a fifth priority indicating a software update to adjust settings of an operational vehicle feature, a sixth priority indicating a preferred update, and a seventh priority indicating a non-imminent update to be scheduled at a customer-specific time.

7. The system of claim 1, wherein the server is further programmed to push the software update to the vehicle responsive to determining by the server that the time is reached.

8. The system of claim 1, wherein the server is further programmed to initiate determination of the priority of the software update responsive to addition of availability of the software update.

9. A method comprising:
including, in a data store, priority data for a software update to a vehicle based on metadata of the software update;
responsive to receiving an indication of a vehicle-specific priority override for the software update for the vehicle, updating the priority data with the vehicle-specific priority override; and
scheduling the software update to the vehicle at a time according to the vehicle-specific priority override and a geographic region of the vehicle.

10. The method of claim 9, further comprising updating the data store to associate the vehicle with the geographic region responsive to receiving, from the vehicle, a message indicating the geographic region in which the vehicle is located.

11. The method of claim 9, further comprising indicating in the metadata that the software update is a mandatory fix for immediate distribution.

12. The method of claim 9, further comprising indicating in the metadata that the software update is a non-essential update.

13. The method of claim 9, wherein the indication of the vehicle-specific priority includes payment for the software update.

14. The method of claim 9, further comprising determining the geographic region of the vehicle according to an origination address of a message received from the vehicle.

15. A non-transitory computer-readable medium comprising instructions, that when executed by a processor, cause the processor to schedule a software update to a vehicle at a time specific to a priority determined using metadata of the software update and a geographic region in which the vehicle identifies in a message to the processor as being located.

16. The medium of claim 15, further comprising instructions to cause the processor to update the time using user-defined timing settings specific to the vehicle.

17. The medium of claim 15, further comprising instructions to cause the processor to:
receive, from the vehicle, a message indicating the geographic region in which the vehicle is located responsive to vehicle presence in the geographic region for a predefined period,
responsive to the message, update a data store to associate the vehicle with the geographic region.

18. The medium of claim 17, further comprising instructions to cause the processor to update the data store to identify the vehicle to associate with the geographic region based on a vehicle identification number (VIN) of the vehicle included in the message.

19. The medium of claim 15, wherein the geographic region corresponds to a political boundary.

20. The medium of claim 15, wherein the priority includes one or more of: a first priority indicating a mandatory fix, a second priority indicating that the vehicle is paid for the software update, a third priority indicating a software update to fix functional issues in one or more features, a fourth priority indicating a software update to provide new features, a fifth priority indicating a software update to adjust settings of an operational vehicle feature, a sixth priority indicating a preferred update, and a seventh priority indicating a non-imminent update to be scheduled at a customer-specific time.
